(19) United States
(12) Patent Application Publication
(10) Pub. No.: US 2017/0351969 A1
(43) Pub. Date: Dec. 7, 2017

(54) EXPLOIT-EXPLORE ON HETEROGENEOUS DATA STREAMS

(71) Applicant: Microsoft Technology Licensing, LLC, Redmond, WA (US)

(72) Inventors: Jignesh Rasiklal Parmar, Santa Clara, CA (US); Abhishek Goswami, Bellevue, WA (US); Sarthak Shah, Kirkland, WA (US)

(21) Appl. No.: 15/174,792

(22) Filed: Jun. 6, 2016

(51) Int. Cl. G06N 99/00; G06F 9/54

(52) U.S. Cl. CPC G06N 99/005; G06F 9/542

(57) ABSTRACT

Machine learning on a heterogeneous event data stream using an exploit-explore model. The heterogeneous event data stream may include any number of different data types. The system featurizes at least part of the incoming event data stream in accordance with a common feature dimension space. The resulting stream of featurized event data is then split into an exploration portion and an exploitation portion. The exploration portion is used to performed machine learning to thereby advance machine knowledge. The exploitation portion is used exploit current machine knowledge. Thus, an automated balance is struck between exploitation and exploration of an incoming event data stream. The automated balancing may even be performed as a cloud computing service.

### BACKGROUND

Computers and networks have ushered in what has been called the “information age”. There is a massive quantity of data available to both humans and machine. This massive quantity of data may also be provided to computing systems to allow the computing system to learn information by observing patterns within the data, without the information being explicitly within the data. This computer-based learning process is often referred to as “machine-learning”.

One trade-off in learning models is referred to as the exploration-exploitation trade-off. This trade-off is a balance between choosing to employ present knowledge to gain more immediate benefit (“exploitation”) and choosing to experiment about something less certain in order to possibly learn more (“exploration”). In machine learning, the knowledge captured within a trained model can be enhanced by exploring rarely occurring data points in further detail, or else by exploring frequently occurring data points for recent changes, due to changes in the environment or market conditions.

Not every foray off track will result in helpful environmental knowledge. However, as a long term strategy, if some resources are devoted to exploration, then environmental knowledge will ultimately increase, resulting in more opportunities to use that information (via exploitation) later. This tradeoff is essentially about balancing immediate benefit vs. immediate sacrifice for long-term benefit balancing the needs of the present with the desires for future improvement. Some conventional computing systems do recognize this balance and thus provide a trade-off in exploitation and exploration when conducting machine learning.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to machine learning on a heterogeneous event data stream using an exploit-explore model. The heterogeneous event data stream may include any number of different data types. The system featurizes at least part of the incoming event data stream in accordance with a common feature dimension space. Thus, regardless of the fact that different data types are received within the event data stream, that data is converted into a data structure (such as a feature vector) that has the same feature dimension space.

The resulting stream of featurized event data is then split into an exploration portion and an exploitation portion. The exploration portion is used to perform machine learning to thereby advance machine knowledge. The exploitation portion is used to exploit current machine knowledge. Thus, an automated balance is struck between exploitation and exploration of an incoming event data stream. The automated balancing may even be performed as a cloud computing service. Thus, an exploit-explore service may be offered to multiple client applications allowing each client application to have an improved and potentially real-time analysis of proper balance of an incoming data stream to optimize current exploitation versus learning (exploration) for future exploitation.

In some embodiments, the split may be dynamically altered. Furthermore, the exploitation and/or exploration may be performed by components and may be switched out for other components. Accordingly, there is a high degree of customization and/or dynamic alterations of the exploit-explore model that may be performed.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computing system in which the principles described herein may be employed;

FIG. 2 illustrates a computing system that implements machine learning on a heterogeneous data stream using a split exploit-explore model in accordance with the principles described herein;

FIG. 3 illustrates a flowchart of a method for machine learning based on a heterogeneous data stream in accordance with the principles described herein;

FIG. 4 illustrates an embodiment of the computing system of FIG. 2 as implemented in a cloud computing environment;

FIG. 5A illustrates a machine learning component library from which the machine learning component of FIGS. 2 and 4 may be drawn;

FIG. 5B illustrates an exploration component library from which the exploration component of FIGS. 2 and 4 may be drawn;

FIG. 5C illustrates an exploitation component library from which the exploitation component of FIGS. 2 and 4 may be drawn; and

FIG. 5D illustrate a splitter component library from which the splitter of FIGS. 2 and 4 may be drawn.

### DETAILED DESCRIPTION

At least some embodiments described herein relate to machine learning on a heterogeneous event data stream using an exploit-explore model. The heterogeneous event data stream may include any number of different data types. The system featurizes at least part of the incoming event data stream in accordance with a common feature dimension space. Thus, regardless of the fact that different data types are received within the event data stream, that data is converted into a data structure (such as a feature vector) that has the same feature dimension space.

The resulting stream of featurized event data is then split into an exploration portion and an exploitation portion. The exploration portion is used to perform machine learning to thereby advance machine knowledge. The exploitation portion is used to exploit current machine knowledge. Thus, an automated balance is struck between exploitation and exploration of an incoming event data stream. The automated balancing may even be performed as a cloud computing service. Thus, an exploit-explore service may be offered to multiple client applications allowing each client application to have an improved and potentially real-time analysis of proper balance of an incoming data stream to optimize current exploitation versus learning (exploration) for future exploitation.

In some embodiments, the split may be dynamically altered. Furthermore, the exploitation and/or exploration may be performed by components and may be switched out for other components. Accordingly, there is a high degree of customization and/or dynamic alterations of the exploit-explore model that may be performed.

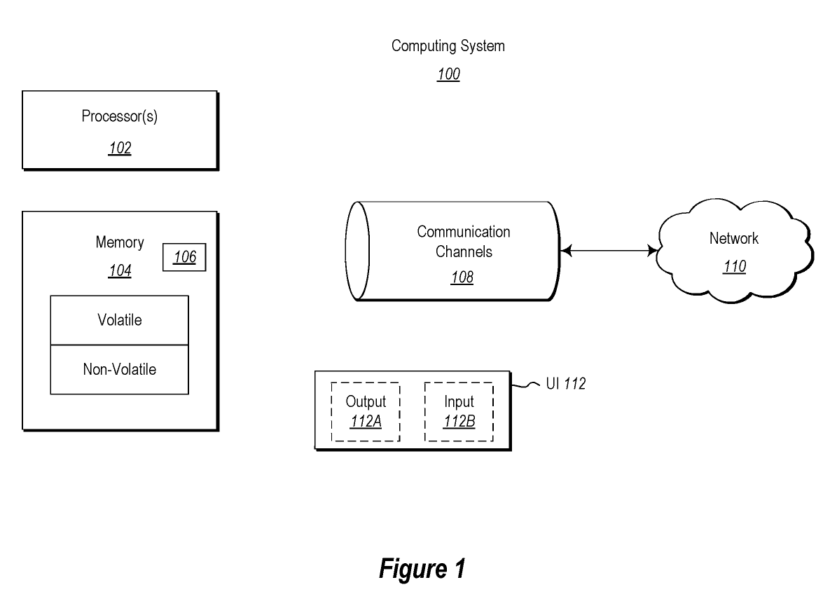

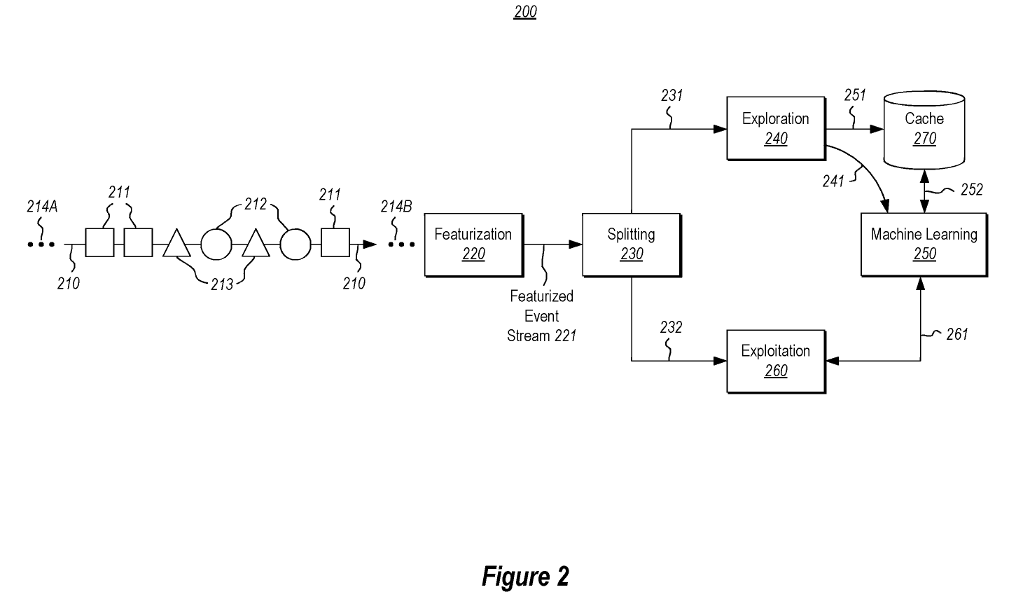

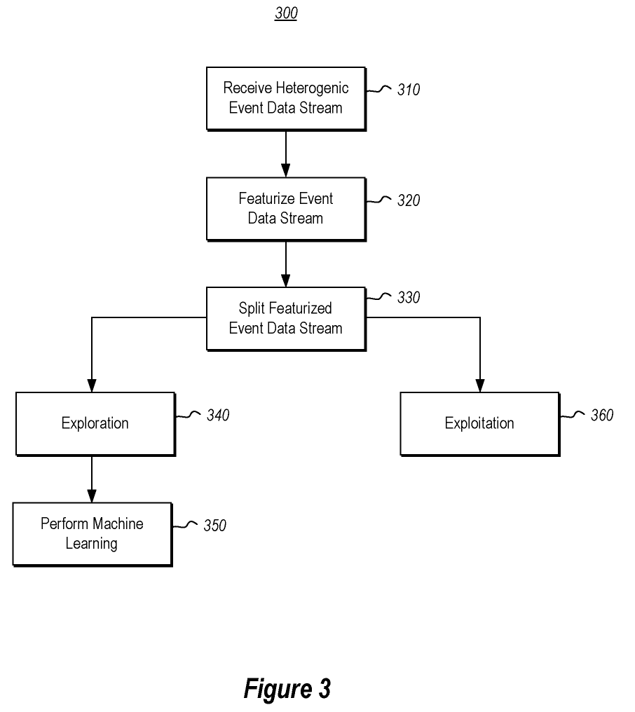

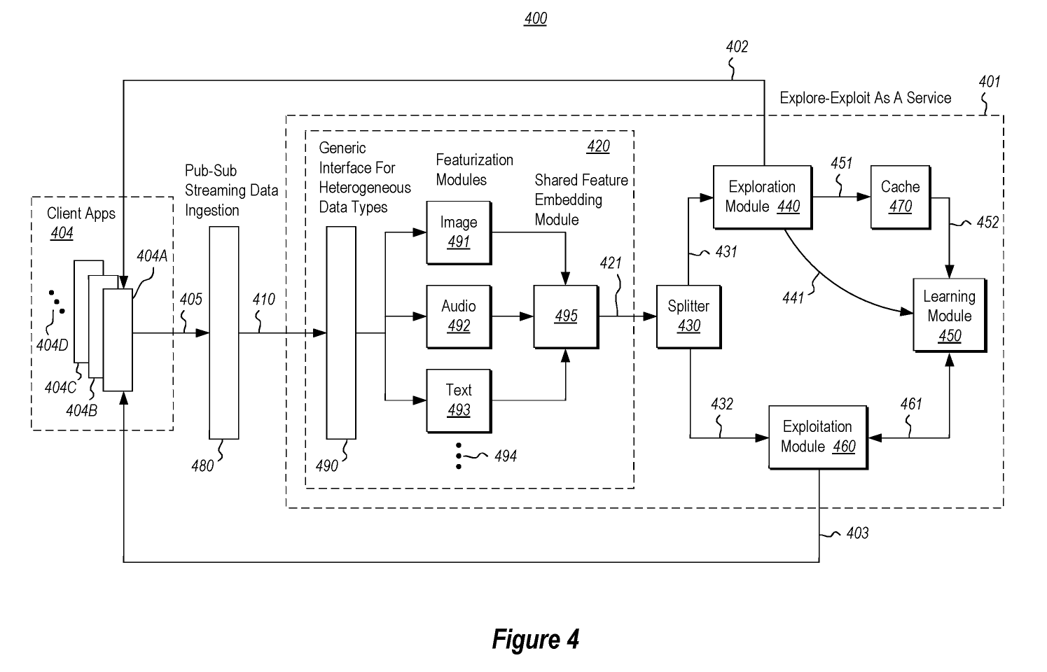

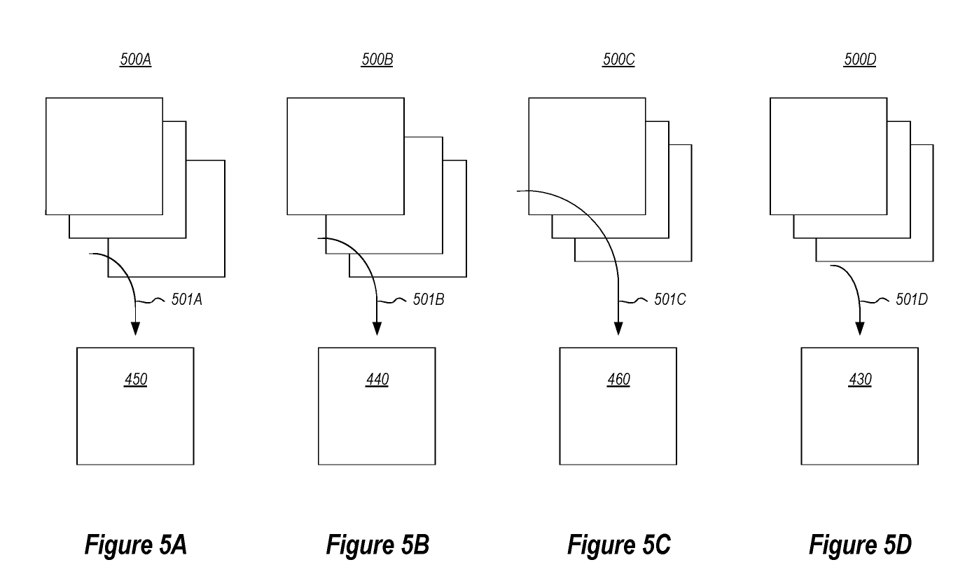

Some introductory discussion of a computing system will be described with respect to FIG. 1. Then, the operation of the machine learning system that implements an explore-exploit model will be described with respect to FIGS. 2 and 3. Finally, the operation of a machine learning service that is implemented in a cloud computing environment will be described with respect to FIGS. 4 through 5D.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 also has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “service”, “engine”, “module”, “virtual machine”, “control” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface 112 for use in interfacing with a user. The user interface 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms, virtual reality elements, and so forth. Examples of input mechanisms 112B might include, for instance, microphones, touchscreens, holograms, cameras, keyboards, mouse of other pointer input, sensors of any type, virtual reality elements, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Now that a computing system 100 and its example structure and operation have been described with respect to FIG. 1, the operation of the machine learning system that implements an exploit-explore model will be described with respect to FIGS. 2 and 3. FIG. 2 illustrates a computing system 200 that implements machine learning on a heterogeneous event data stream using a split exploit-explore model. The computing system 200 may be structured and operate as described above for the computing system 100 of FIG. 1.

The computing system 200 receives a heterogenic event data stream 210 of multiple data types. For instance, the heterogenic data stream 210 is illustrated as including events of a first particular data type 211 (each represented by squares), events of a second particular data type 212 (as represented by circles) and events of a third particular data type 213 (as represented by triangles).

The ellipses 214A and 214B represent that the event data stream is continuous and that the illustrated event data stream is but a small portion of the event data stream. The ellipses 214A and 214B also represent that the principles described herein are not limited to the data types that are within the event data stream, nor the number of data types that are within the event data stream. As an example only, the data types might be image data types, video data types, audio data types, text data types, and/or other data types.

FIG. 3 illustrates a flowchart of a method 300 for machine learning based on a heterogeneous data stream. As the method 300 of FIG. 3 may be performed in the context of the computing system 200 of FIG. 2, the method 300 will be described with frequent reference to both FIGS. 2 and 3. The method 300 includes receiving a heterogenic event data stream of multiple data types (act 310). As an example, in FIG. 2, the computing system 200 receives the event data stream 210.

According to FIG. 3, as events are received, those events are featurized (act 320) into a common feature dimension space. As an example, one or more features of the data of any given data type are extracted, and such features are represented along one dimension. For instance, the collection of features may be represented as a feature vector. Referring to FIG. 2, the featurization into a common feature dimension space may be performed by the featurization component 220 of FIG. 2, resulting in a featurized event stream 221.

The feature vectors for all of the data types are in a common feature dimension space in that each feature vector has a collection of the same type of features, regardless of the event data type. In order to provide for efficient processing of the feature vectors, and although not required, the features are also aligned so that the type of feature is determined by its position within the vector in the same manner regardless of the event data type. Furthermore, in order to provide for efficient processing of feature vectors, and although not required, none of the feature vectors include features other than those of the collection of the same type of features. Thus, vector operations, such as comparisons, can be quickly performed between feature vectors of the featurized event stream 221.

Next, the featurized event stream is split (act 330) with a portion of the featurized event data directed towards exploration (act 340) on which machine learning is performed (act 350). Machine learning is also performed on the exploitation events. Another portion of the featurized event data is split (act 330) towards exploitation (act 360) based on current machine understanding. Because the method 300 is performed on a stream of incoming event data, and thus on a stream of featurized event data, the acts of receiving, featurizing, splitting, exploration to perform new machine learning, and exploitation of current machine learning may be repeatedly and continuously performed. Thus, the method 300 may be considered to be a processing flow pipeline thereby causing substantially real-time exploration and exploitation.

For instance, as shown in FIG. 2, a featurized event stream 221 is split by splitting component 230 into a first portion 231 that is directed towards an exploration component 240, and a second portion 232 that is directed towards an exploitation component 260. The exploitation component 260 is coupled (as represented by arrow 261) to a machine learning component 250 that has the current level of machine learning and understanding. The exploitation component 260 may thus make decisions on each of the incoming featurized event data streams to thereby advance a goal for more immediate rewards. The exploration component 240 is also coupled (as represented by arrow 241) to the machine learning component 250 so as to alter and likely improve the level of machine understanding of the machine learning component 250.

The machine learning component 250 supports real-time learning from featurized event data. Learning algorithms that adapt to learning in a distributed, parallel fashion may be supported. Learning models from distributed nodes may be combined into a single combined learning model. The learning component may support multiple learning algorithms such as learning with counts, stochastic gradient descend, deep learning, and so forth.

In some embodiments, there may be a machine learning cache 270 interposed between the exploration component 240 and the machine learning component 260. The machine learning cache 270 accumulates featurized event data that is split towards exploration. Thus, the exploration component 240 may perform machine learning not on a live featurized stream of events, but on accumulated featurized stream of events. The cache 270 may be configured as a key/attribute store with a schema-less design. The cache 270 may support real-time updates to an unstructured data cache in the cloud. The cache 270 may also support featurization in the cloud, and may be a multi-concurrency cache. This enables real-time lookups key-lookup. Having a cache means access to data is fast, fast data access, and ease of adaption to different scenarios and applications. This gives us the ability to store flexible datasets, such as user data for web applications, address books, device information, and any other type of data that the client application calls for.

The communication between the exploration component 240 and the machine learning cache 270 is represented by the arrow 251. As represented by arrow 251, featurized event data may be written by the exploration component 240 to the machine learning cache 270. Since the arrow 251 is bi-directional, the arrow 251 also represents reading of the accumulated featurized event data from the machine learning cache by the exploration component 240 in order to perform machine learning. The arrow 251 also represents the writing of resulting machine learning knowledge back to the machine learning cache 270.

The arrow 252 represents that the machine learning component may read the new machine learning knowledge from the machine learning cache 270. This thereby advances the knowledge of the machine learning component 250. Thus, splitting a portion of the featurized event data towards the exploration component 240 allows for the body of machine learning to be advanced.

The machine learning cache 270 is not necessary. It is possible to perform machine learning on a stream of featurized events, one featurized event at a time. In that embodiment, the exploration component 240 learns, and passes that learning along (as represented by arrow 241) to the machine learning component 260. Either way, the employment of exploration allows for advancement in machine learning.

Now that the general operation of the machine learning system that implements an exploit-explore model has been described with respect to FIGS. 2 and 3, the operation of a machine learning service that is implemented in a cloud computing environment will be described with respect to FIGS. 4 through 5D.

FIG. 4 illustrates an embodiment 400 of the computing system 200 of FIG. 2 as implemented in a cloud computing environment 401. The elements 410, 420, 421, 430, 431, 432, 440, 441, 450, 451, 452, 460, and 461 of FIG. 4 may operate and be examples of the corresponding elements 210, 220, 221, 230, 231, 232, 240, 241, 250, 251, 252, 260, and 261 of FIG. 2. However, the cloud computing environment 401 is also illustrated as including additional flows 402 and 403. Furthermore, outside the cloud computing environment 401, there are client applications 404 and streaming data ingestion component 480, and flow 405 illustrated.

The client applications 404 represents consumers of the illustrated exploit-explore service provided by the cloud computing environment 401. Presently, the exploit-explore service is provided to the client application 404A. However, the presence of client applications 404B and 404C represent that the principles described herein may be extended to provide similar exploit-explore services to multiple clients. However, for each client application, there may be a custom objective function upon which machine learning is performed. As illustrated in FIG. 4, the exploration component 440 is exploring by providing output 402 to the client application 404A. The exploitation component 460 is exploiting by providing output 403 to the client application 404A.

The splitting of the data stream between the exploitation component 460 and the exploration component 440 balances the trade-off between choosing to employ present knowledge to gain more immediate benefit (“exploitation”) and choosing to experiment about something less certain in order to possibly learn more (“exploration”).

For instance, one client application might be a news service. In that case, the objective function might be to present news items of interest (e.g., maximize the chance that a user will select more details to read about one of the articles on the front page). If the client application were an online marketplace, the objective function might be to present products having a higher likelihood of resulting in a purchase. If the client application were an airline reservation page, the objective function might be to present possible routes that are more likely to be desired by the user, or present routes that are more likely to be purchased by the user.

The different client applications may have different objective functions. Accordingly, a different learning module 450 might be appropriate to achieve the different objective functions. Likewise, different exploration components 440 may be used in order to best learn how to achieve the corresponding objective function. Furthermore, different exploitation components 460 may be used in order to best exploit present machine knowledge to achieve the corresponding objective function.

Even different splitters 430 may be used to achieve a different splitting algorithm appropriate to the client's willingness to balance exploration and exploitation. For instance, in some splitters, the balance of the split between the exploration and exploitation may be configurable by the user, and/or may dynamically change. Some splitters may have a tendency towards faster learning via more dedication to exploitation. Some splitters may have a tendency towards quicker exploitation of present machine knowledge.

For instance, FIG. 5A illustrates a machine learning component library 500A from which the machine learning component 450 may be drawn (as represented by arrow 501A). Furthermore, FIG. 5B illustrates an exploration component library 500B from which the exploration component 440 may be drawn (as represented by arrow 501B). Also, FIG. 5C illustrates an exploitation component library 500C from which the exploitation component 460 may be drawn (as represented by arrow 501C). Finally, FIG. 5D illustrate a splitter component library 500D from which the splitter 430 may be drawn (as represented by arrow 501D).

Although three client applications 404A, 404B and 404C are illustrated as being the client applications 404 that are using the exploit-explore cloud computing service of the cloud computing environment 401 of FIG. 4, the ellipses 404D represent that there may be other numbers of client applications with diverse objective functions that use the exploit-explore service. Each client application may custom configure the exploit-explore service with the proper splitter, exploration, exploitation, and/or machine learning components.

The streaming data ingestion component 480 is capable of receiving large flows of streaming data, on the order of perhaps even millions of events per second. In one embodiment, the streaming data ingestion component is a high volume publish-subscribe service (e.g., EventHub, Kakfa). As an example, the streaming data ingestion component 480 receives event data from the client application 404A as represented by the arrow 405. However, the streaming data ingestion component 480 may receive events from numerous client application via, for instance, publication.

In FIG. 4, the featurization component 420 is an example of the featurization component 220 of FIG. 2, but shows more structure regarding how featurization of a heterogenic event data stream might be efficiently performed. The featurization component 420 includes a generic interface 490 for heterogeneous data types that receives the event data stream 410. The generic interface 490 determines the data type of each event and forwards the event data to the appropriate type-specific featurization component 491, 492 or 493. In the illustrated embodiment, there is an image featurization component 491, an audio featurization component 492, and a text featurization component 493. However, the ellipses 494 represent that there may be any number and type of event data that could be received. Accordingly, depending on the client application, the type-specific featurization components may also be drawn from a library of type-specific components. The component 495 represents that each type-specific featurization component featurizes the event into a common feature dimension space, regardless of the event data type. There may be multiple instances of the common feature embedding component 495 in operation.

The generic interface 490 subscribes to the event stream 410 from the streaming data ingestion component 480. The generic interface 490 can ingest for featurization both structured and unstructured data. The generic interface 490 also allows the ability to handle different data formats. In that case, the interface is designed to appropriately invoke separate downstream modules that can handle specific data formats. Thus, the combination of the streaming data ingestion component 480 and the generic interface 490 (with its supporting downstream featurization components) allows for an exploit-explore model that is highly scalable when implemented in a cloud computing environment, can handle events of a variety of heterogeneous data types, and that can handle events of structured as well as unstructured data.

The present invention may be embodied in other forms, without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computing system that implements machine learning on a heterogeneous data stream using a split exploit-explore model, the computing system comprising:
one or more processors;
one or more computer-readable media having thereon computer-executable instructions that are structured such that, when executed by the one or more processors, cause the computing system to perform a method for machine learning based on a heterogeneous data stream, the method comprising:
an act of receiving a heterogenic event data stream of multiple data types;
an act of featurizing at least some of the event data of the heterogenic event data stream into a common feature dimension space; and
an act of splitting a stream of the featurized event data into a portion that is directed towards exploration on which machine learning is performed using at least some of the portion of the featurized event data, and a portion that is directed towards exploitation based on current machine understanding.

2. The computing system in accordance with claim 1, the acts of receiving, featurizing and splitting being repeatedly performed.

3. The computing system in accordance with claim 1, the acts of receiving, featurizing and splitting being continuously performed.

4. The computing system in accordance with claim 1, the computing system implemented in a cloud computing environment.

5. The computing system in accordance with claim 1, the method being performed multiple times for each of multiple data streams.

6. The computing system in accordance with claim 5, wherein for each of at least some of the multiple data streams, an optimization goal for exploitation is different.

7. The computing system in accordance with claim 5, wherein for each of at least some of the multiple data streams, machine learning is performed for a different client application of a cloud computing service.

8. The computing system in accordance with claim 1, the computing system further comprising:
a machine learning cache that accumulates a plurality of featurized event data split towards exploration so that machine learning is performed using a collection of the featurized event data.

9. The computing system in accordance with claim 1, the machine learning performed on the featurized event data split towards exploration being performed on the featurized event data as a stream of event data.

10. The computing system in accordance with claim 1, wherein a balance of splitting is configurable.

11. The computing system in accordance with claim 1, wherein a balances of the splitting dynamically changes.

12. The computing system in accordance with claim 1, wherein exploitation is performed by an exploitation component.

13. The computing system in accordance with claim 12, the exploitation component chosen from a library of exploitation components.

14. The computing system in accordance with claim 13, the exploitation component being switchable with another exploitation component of the library of exploitation components.

15. The computing system in accordance with claim 1, wherein exploration is performed by an exploration component.

16. The computing system in accordance with claim 15, the exploration component chosen from a library of exploration components.

17. The computing system in accordance with claim 16, the exploration component being switchable with another exploration component of the library of exploration components.

18. A method for machine learning based on a heterogeneous data stream, the method comprising:
an act of receiving a heterogenic event data stream of multiple data types;
an act of featurizing at least some of the event data of the heterogenic event data stream into a common feature dimension space; and
an act of splitting a stream of the featurized event data into a portion that is directed towards exploration on which machine learning is performed using at least some of the portion of the featurized event data, and a portion that is directed towards exploitation based on current machine understanding.

19. The method in accordance with claim 18, the method being performed multiple times for each of multiple data streams, wherein for each of at least some of the multiple data streams, machine learning is performed for a different client application of a cloud computing service.

20. A computer program product comprising one or more computer-readable storage media have thereon computer-executable instructions that are structured such that, when executed by one or more processors of a computing system, cause the computing system to perform a method for machine learning based on a heterogeneous data stream, the method comprising:
an act of receiving a heterogenic event data stream of multiple data types;
an act of featurizing at least some of the event data of the heterogenic event data stream into a common feature dimension space; and
an act of splitting a stream of the featurized event data into a portion that is directed towards exploration on which machine learning is performed using at least some of the portion of the featurized event data, and a portion that is directed towards exploitation based on current machine understanding.
